(19) United States
(12) Patent Application Publication
(10) Pub. No.: US 2026/0131344 A1
(43) Pub. Date: May 14, 2026

(54) SHOWER HEAD WITH DESCALING ABILITY

(71) Applicant: Xiamen Easo Co., Ltd., Xiamen (CN)

(72) Inventors: YANG-YU ZHANG, Xiamen (CN); Yujie Xu, Xiamen (CN); Zhen Li, Xiamen (CN); Haitao Lu, Xiamen (CN)

(21) Appl. No.: 19/387,667

(22) Filed: Nov. 13, 2025

(30) Foreign Application Priority Data
Nov. 14, 2024 (CN) 202411622129.6

(51) Int. Cl. B05B 15/522; B05B 1/18

(52) U.S. Cl. CPC B05B 15/5225; B05B 1/182

(57) ABSTRACT

A shower head with descaling ability includes: a housing provided with a plurality of nozzles; and a moving plate movably received in the housing and provided with a plurality of ejection pins configured to be inserted into the plurality of nozzles, respectively. The shower head is further provided with a first water inlet and a second water inlet, the water flowing into the first water inlet flows below the moving plate and drives the moving plate to move away from the nozzles, so that the ejection pins are disengaged from the nozzles and the water then flows out from the nozzles. The water flowing into the second water inlet flows above the moving plate and presses the moving plate to move towards the nozzles, so that the ejection pins are inserted into the nozzles to eject scales out of the nozzles.

### CROSS-REFERENCE TO RELATED APPLICATIONS

This application claims priority to Chinese Patent Application No. 202411622129.6, filed on November 14, 2024, entitled “AUTOMATIC DESCALING SHOWER HEAD”, the entire content of which is incorporated herein by reference in its entirety.

### TECHNICAL FIELD

The present disclosure relates to a shower head with descaling ability.

### BACKGROUND

In many regions, the water quality is poor and relatively hard, which makes it easy to form a scale. The scale can easily block a water nozzle of a shower head, resulting in a reduced water flow or split water streams, which affects the usage experience, especially the shower experience, resulting in poor water spray performance and incomplete water coverage. In conventional shower heads, an ejection plate is pushed manually to remove the scale from the water nozzle, which is time-consuming and labor-intensive. An elastic member may be provided to reset the ejection plate, however, this structure is complicated and requires an installation position for the elastic member. The elastic member is prone to be failure, and the number of parts is increased, which not only increases the cost, but also increases the difficulty of production.

### SUMMARY

Accordingly, it is necessary to provide a shower head with descaling ability.

A shower head with descaling ability includes: a housing provided with a plurality of nozzles; and a moving plate movably received in the housing and provided with a plurality of ejection pins configured to be inserted into the plurality of nozzles, respectively. The shower head is further provided with a first water inlet and a second water inlet, water flowing into the first water inlet flows below the moving plate and drives the moving plate to move away from the nozzles, so that the ejection pins are disengaged from the nozzles and the water then flows out from the nozzles, the water flowing into the second water inlet flows above the moving plate and presses the moving plate to move towards the nozzles, so that the ejection pins are inserted into the nozzles to eject scales out of the nozzles.

In an embodiment, the housing includes a panel, the nozzles are provided on the panel, the shower head further includes a water separating plate and a water dividing tray that are provided in the housing, the moving plate is movably provided between the water separating plate and the panel, and the water dividing tray is located on a side of the water separating plate away from the panel.

In an embodiment, a first water dividing cavity is formed between the water dividing tray and the water separating plate, the first water dividing cavity is in communication with the first water inlet, the water flowing into the first water dividing cavity flows below the moving plate through the first water inlet, the water separating plate is provided with a first guide column, the first water inlet extends through the first guide column, the moving plate is provided with a first guide hole, and the first guide column is inserted into the first guide hole.

In an embodiment, the panel is provided with a connecting ring surrounding the first guide column, a top surface of the connecting ring is higher than or flush with a bottom surface of the first guide column, a first water outlet cavity is formed between the panel and the moving plate, and the first water outlet cavity is in communication with the first water inlet and the plurality of nozzles.

In an embodiment, a lower end surface of the moving plate is provided with an upwardly recessed groove located above the connecting ring, the water flowing into the first water inlet flows to the connecting ring and then flows upward to the upwardly recessed groove, and flows downward into the first water outlet cavity and flows out from the nozzles.

In an embodiment, a second water dividing cavity is formed between the water dividing tray and the water separating plate, the second water inlet is formed in the water separating plate, the second water dividing cavity is in communication with the second water inlet, the water flowing into the second water dividing cavity flows above the moving plate through the second water inlet, and the moving plate is provided with a second guide column configured to be inserted into the second water inlet.

In an embodiment, the shower head further includes a sealing ring provided between an outer peripheral wall of the second guide column and an inner wall of the second water inlet.

In an embodiment, the second guide column is provided with a downwardly recessed groove, and the water from the second water dividing cavity acts in the downwardly recessed groove through the second water inlet, so as to move the moving plate downward.

In an embodiment, the housing is further provided with a water inlet cavity, the shower head further comprises a water dividing sheet rotatably received in the water inlet cavity, the water dividing sheet is rotated to allow the water to flow into the first water inlet or the second water inlet, and a plurality of sealing members are provided between the water dividing sheet and the water dividing tray.

In an embodiment, the shower head further includes a switching assembly mounted on the housing, and the switching assembly is connected to the water dividing sheet and is configured to drive the water dividing sheet to rotate.

In an embodiment, the switching assembly includes a push button provided on the housing, a push rod, a gear, and a rotating shaft that are located in the housing, the push rod is drivingly connected to the push button, the push rod is provided with a rack engaged with the gear, one end of the rotating shaft is fixed to the gear, and another end of the rotating shaft is located in the water inlet cavity and is fixed to the water dividing sheet.

The shower head has the following beneficial effects. 1. Descaling is performed by water pressure, making the structure simpler and the cost lower; 2. The water pressure force is balanced and a more stable mechanical pressing is achieved; 3. Descaling is performed when switching the water path by operating the push button, making the overall operation simpler; 4. No elastic mechanism is required, which can make the structural design simpler, reduce the difficulty of production, and reduce the number of parts.

### BRIEF DESCRIPTION OF THE DRAWINGS

In order to illustrate the embodiments of the present disclosure more clearly, the drawings used in the embodiments or the conventional art will be described briefly. Apparently, the following described drawings are merely for the embodiments of the present disclosure, and other drawings can be derived by those of ordinary skill in the art without any creative effort.

FIG. 1 is a bottom view of a shower head according to an embodiment of the present disclosure.

FIG. 2 is a partial cross-sectional view of the shower head of FIG. 1.

FIG. 3 is a schematic view illustrating an internal structure of the shower head.

FIG. 4 is a partial cross-sectional view illustrating ejection pins of the shower head inserted into nozzles.

FIG. 5 is a partial cross-sectional view illustrating water flowing through a second water dividing cavity of the shower head.

FIG. 6 is a partial cross-sectional view illustrating the ejection pins disengaged from the nozzles.

FIG. 7 is a partial cross-sectional view illustrating water flowing through a first water dividing cavity of the shower head.

FIG. 8 is a schematic view of a water separating plate of the shower head.

FIG. 9 is a perspective view of a moving plate of the shower head.

### DETAILED DESCRIPTION OF THE EMBODIMENTS

In order to make the above objectives, technical solutions and advantages of the present application clearer, the specific embodiments of the present application are described in detail below in combination with the accompanying drawings. Apparently, the described embodiments are some of the embodiments of the present disclosure, but not all of them. The following detailed description of the embodiments of the present disclosure provided in the accompanying drawings is not intended to limit the scope of the present disclosure, but merely represents selected embodiments of the present disclosure. Therefore, based on the embodiments in this present disclosure, all other embodiments obtained by those skilled in the art without departing from the connotation of the present application should fall within the scope of protection of the present invention.

In the description of the present application, it should be understood that the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential direction” are based on the azimuths or position relationships shown in the attached drawings. These terms are only for the convenience of describing the present application and simplifying the description, rather than indicating or implying that the indicated devices or elements must have the specific azimuths, or be constructed or operated in the specific azimuths, and therefore such terms cannot be understood as limitations of the present application.

In addition, the terms “first” and “second” are only used for descriptive purposes and cannot be understood as indicating or implying relative importance or implicitly indicating the number of indicated technical features. Thus, the features defined with “first” and “second” may explicitly or implicitly include at least one of the features. In the description of the present application, “a plurality of” means at least two, unless otherwise expressly and specifically defined.

In the present application, unless otherwise expressly specified and limited, the terms “mount”, “connect”, “couple”, “fix” and the like should be interpreted broadly. For example, the terms can mean fixed connection, detachable connection, or being integrated. The terms can mean mechanical connection or electrical connection. The terms can mean directly connection or indirectly connection through an intermediate medium. The terms can mean connection within two elements or interaction relationship between two elements, unless otherwise expressly limited. For those skilled in the art, the specific meaning of the above terms in the present application should be understood according to the specific situation.

In the present application, unless otherwise expressly specified and limited, a first feature “above” or “below” a second feature may be in direct contact with the second feature, or the first and second features may be in indirect contact through an intermediate medium. Moreover, the first feature “above” the second feature may be right above or obliquely above the second feature, or the first feature may be merely located at a height higher than the second feature. The first feature “below” the second feature may be right below or obliquely below the second feature, or the first feature may be merely located at a height lower than that of the second feature.

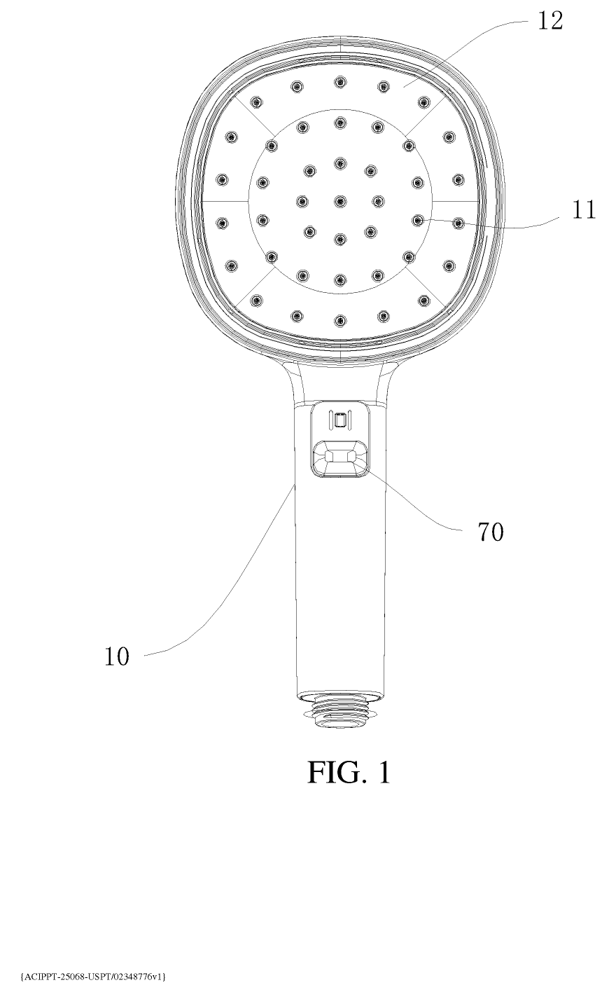

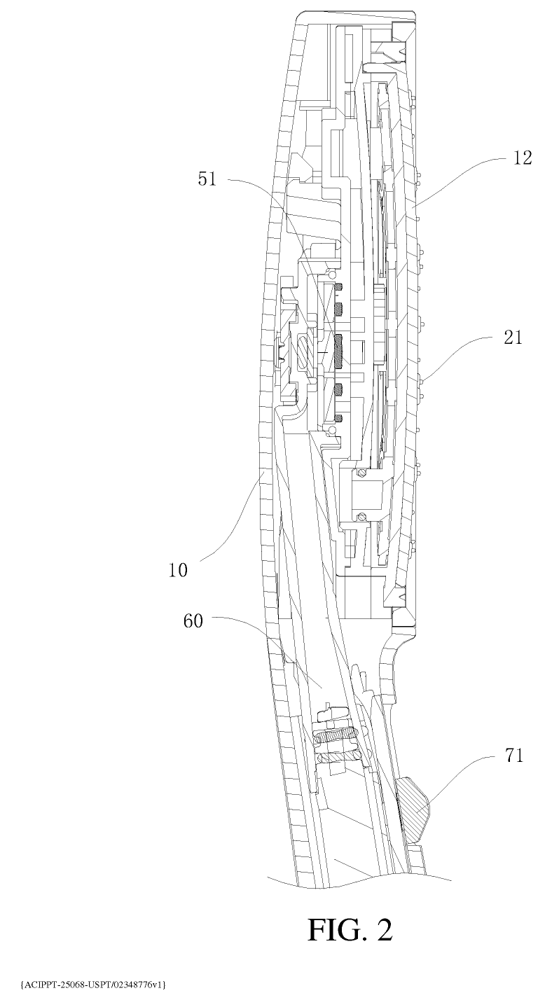

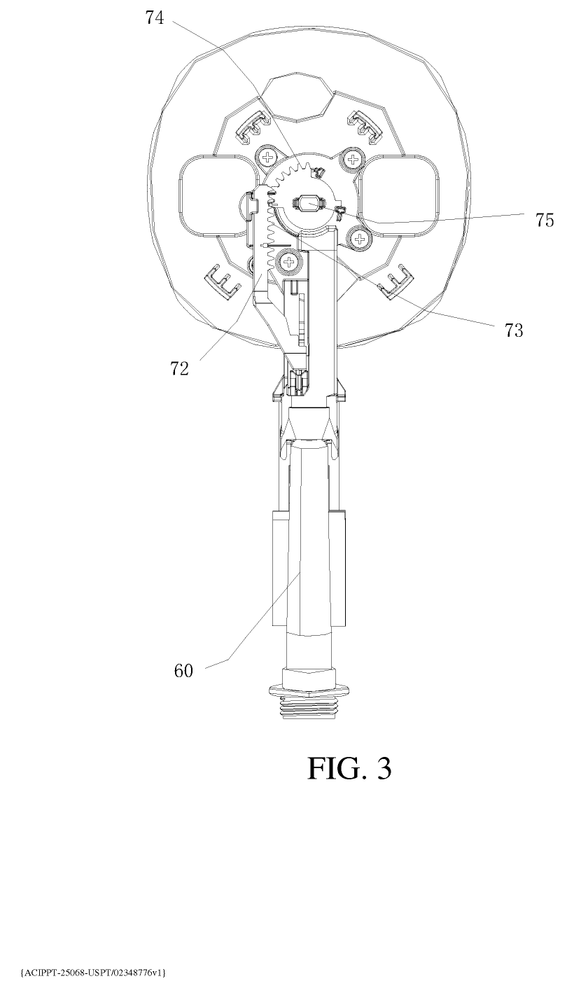

Referring to FIGS. 1 to 9, a shower head with descaling ability according to an embodiment is provided, which includes a housing 10 and a moving plate 20 movably received in the housing 10. The housing 10 is provided with a plurality of nozzles 11 configured to allow water to flow out. The moving plate 20 is provided with a plurality of ejection pins 21 configured to be inserted into the plurality of nozzles 11, respectively. The shower head is further provided with a first water inlet 31 and a second water inlet 32, and water can selectively flow into the first water inlet 31 or the second water inlet 32. The water flowing into the first water inlet 31 can flow below the moving plate 20 and drive the moving plate 20 to move away from the nozzles 11 through the reverse impact and/or buoyancy of the water, so that the ejection pins 21 can be disengaged from the nozzles 11 and the water can then flow out from the nozzles 11. In this case, the shower head may be in a shower mode. The water flowing into the second water inlet 32 can flow above the moving plate 20 and press the moving plate 20 to move towards the nozzles 11, so that the ejection pins 21 can be inserted into the nozzles 11 to eject scales out of the nozzles 11. In this case, the shower head may be in a pause mode. In the shower head, no elastic member is necessarily provided, which reduces the number of parts, and there is no need to provide an installation position of the elastic member in the housing 10, which simplifies the whole structure of the shower head.

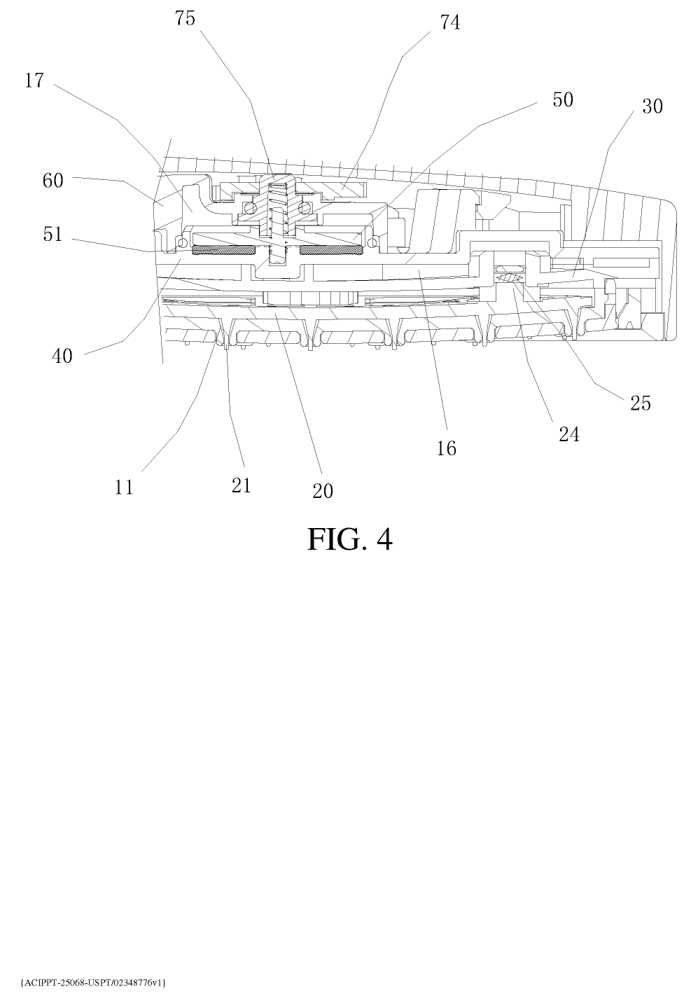

In an embodiment, referring to FIG. 1, the housing 10 includes a panel 12, and the plurality of nozzles 11 are provided on the panel 12. Referring to FIG. 4, the shower head further includes a water separating plate 30 and a water dividing tray 40 that are provided in the housing 10. The moving plate 20 is movably provided between the water separating plate 30 and the panel 12. The water dividing tray 40 is located on a side of the water separating plate 30 away from the panel 12. The water dividing tray 40 cooperates with the housing 10 to form a plurality of water channels, and each water channel can form a type of a water splash.

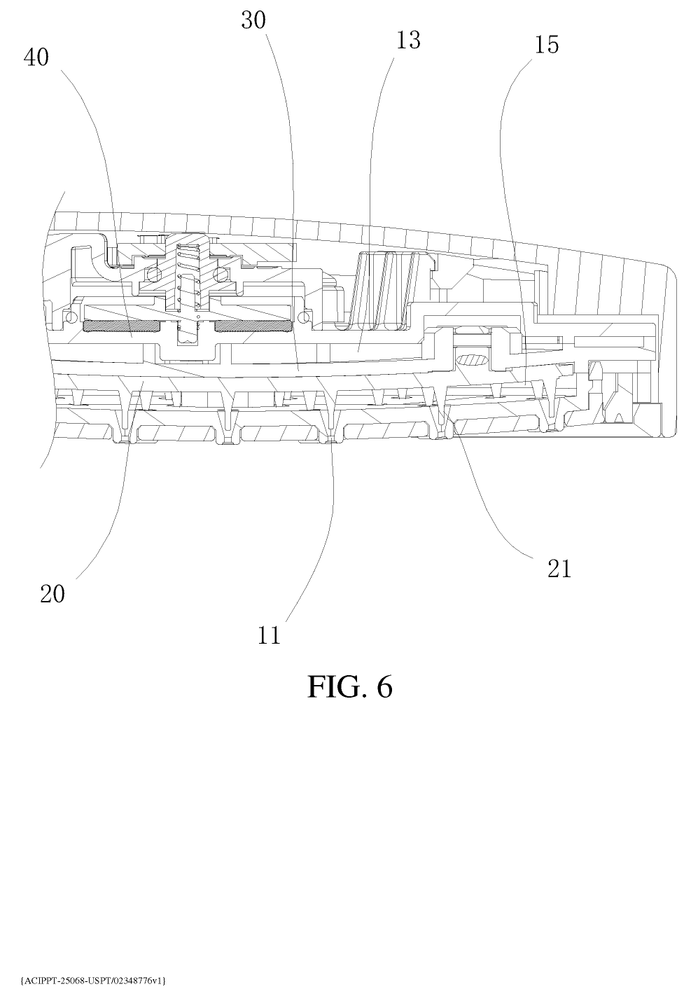

Referring to FIG. 6, a first water dividing cavity 13 is formed between the water dividing tray 40 and the water separating plate 30. The first water dividing cavity 13 is in communication with the first water inlet 31, and the water flowing into the first water dividing cavity 13 can flow below the moving plate 20 through the first water inlet 31.

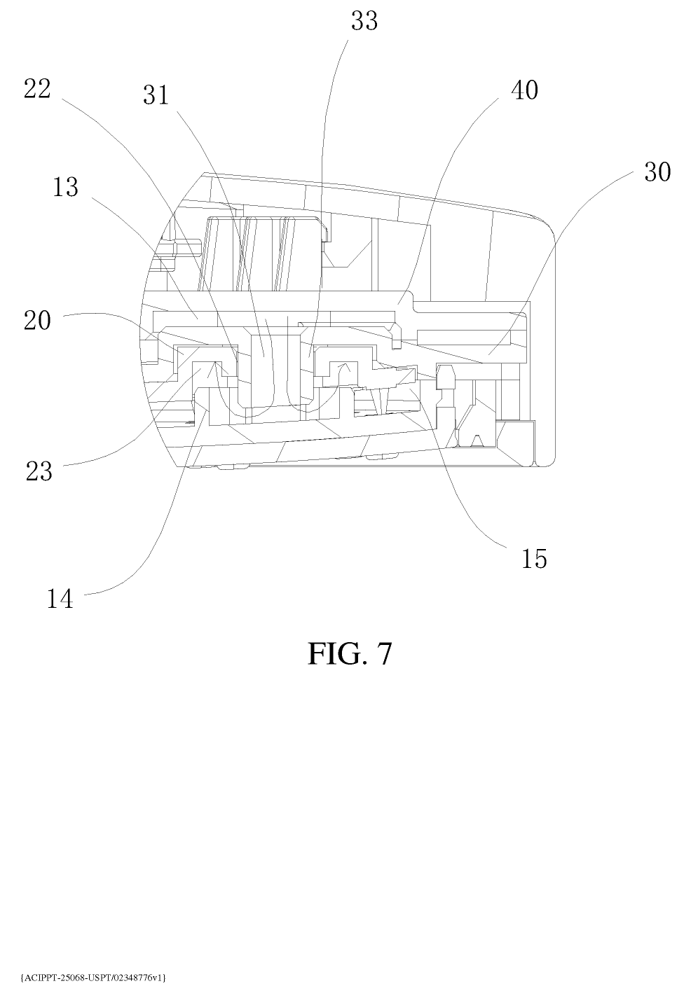

Referring to FIGS. 7 to 9, the water separating plate 30 is provided with a first guide column 33, and the first water inlet 31 extends through the first guide column 33. The moving plate 20 is provided with a first guide hole 22, and the first guide column 33 is inserted into the first guide hole 22. The panel 12 is provided with a connecting ring 14 surrounding the first guide column 33. A top surface of the connecting ring 14 is higher than or flush with a bottom surface of the first guide column 33, so that the water can flow out of the nozzles 11 after being diverted multiple times. Specifically, the water flows downward into the first water inlet 31, then flows upward when reaching the connecting ring 14, and flows downward when touching a lower end surface of the moving plate 20 and flows out from the nozzles 11.

In an embodiment, a first water outlet cavity 15 can be formed between the panel 12 and the moving plate 20, and the first water outlet cavity 15 is in communication with the first water inlet 31 and the nozzles 11. The water flowing into the first water inlet 31 flows out of the nozzles 11 through the first water outlet cavity 15.

In an embodiment, the lower end surface of the moving plate 20 is provided with an upwardly recessed groove 23 located above the connecting ring 14, so that the water flowing into the first water inlet 31 can flow to the connecting ring 14 and then flow upward to the upwardly recessed groove 23, and flow downward into the first water outlet cavity 15 and flow out from the nozzles 11, thereby forming multiple diversions of the water flow. Specifically, a water channel is provided between the connecting ring 14 and an inner peripheral wall of the upwardly recessed groove 23. The water flowing into the first water inlet 31 can flow to the connecting ring 14 and then flow upward to the upwardly recessed groove 23 through the water channel.

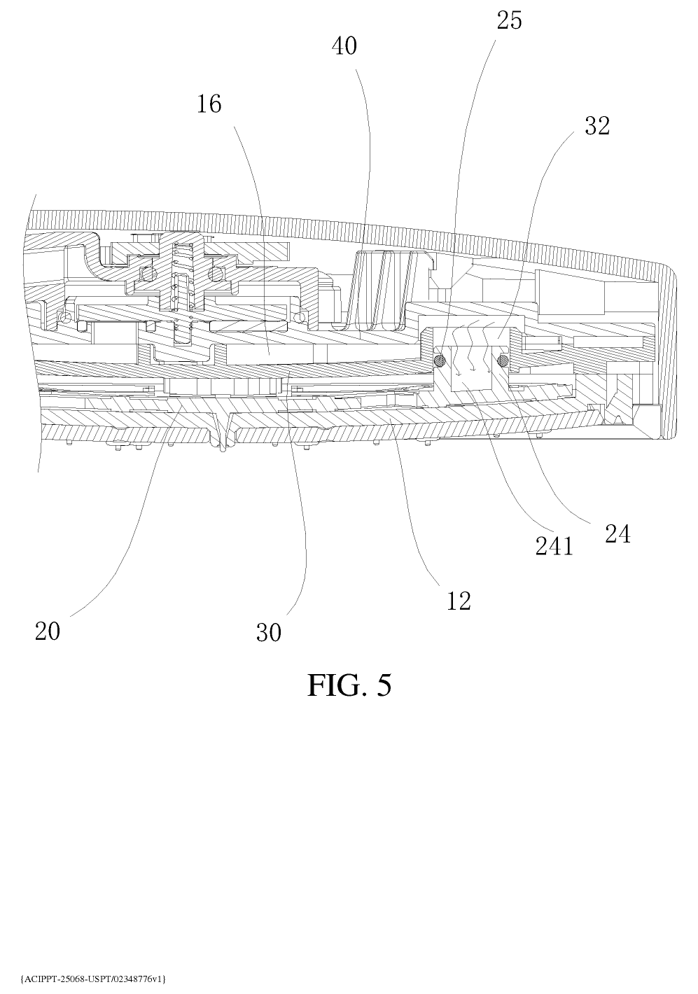

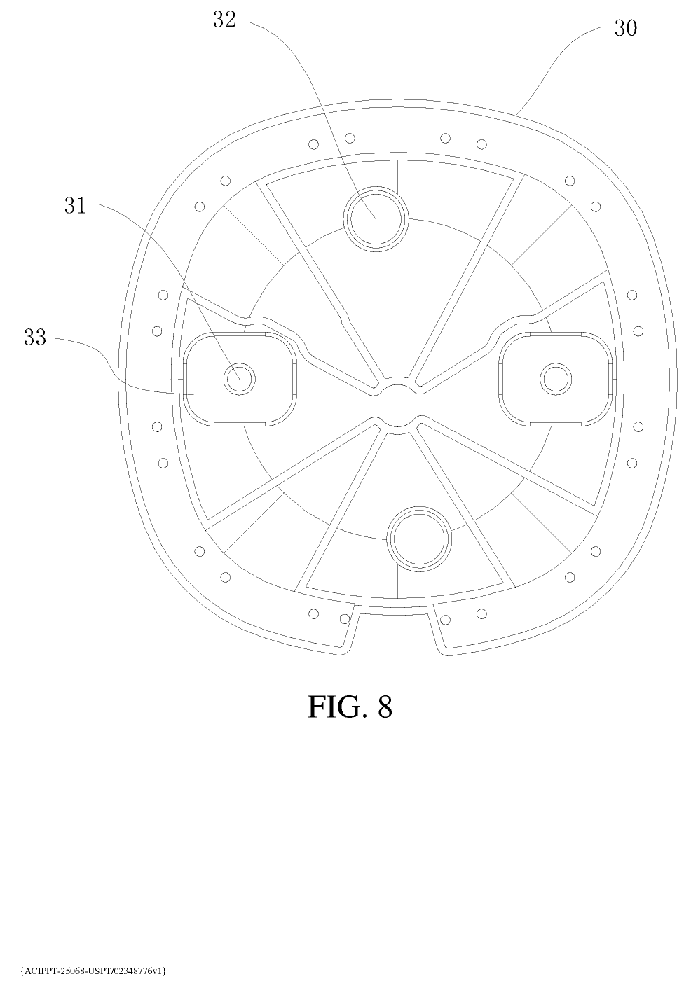

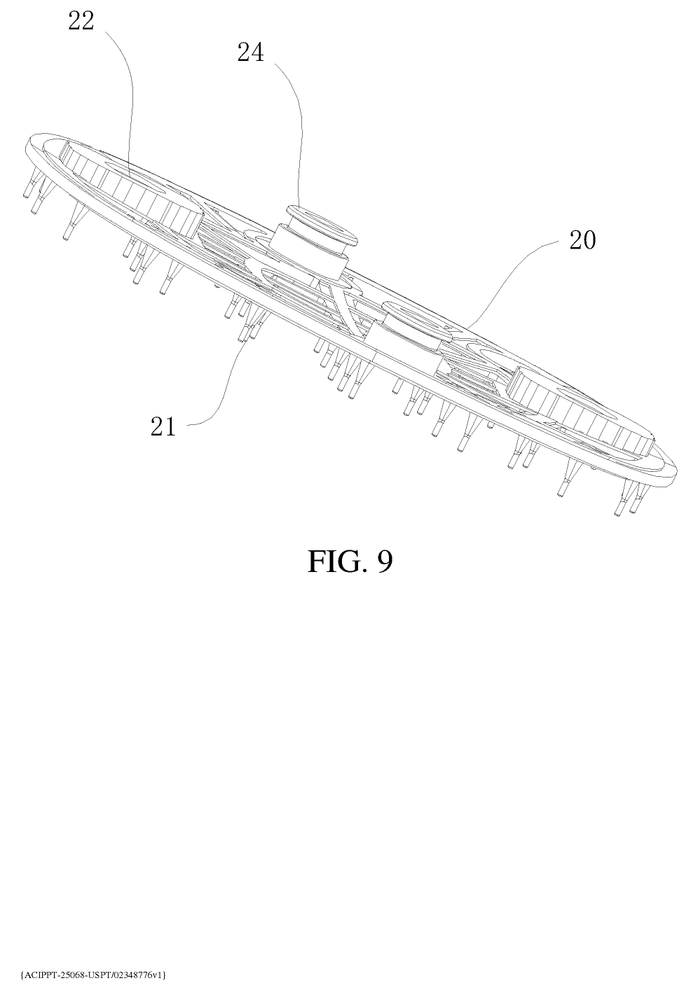

In an embodiment, referring to FIG. 4, FIG. 5, FIG. 8 and FIG. 9, the second water inlet 32 is formed in the water separating plate 30. A second water dividing cavity 16 is formed between the water dividing tray 40 and the water separating plate 30. The second water dividing cavity 16 is in communication with the second water inlet 32, and the water flowing into the second water dividing cavity 16 can flow above the moving plate 20 through the second water inlet 32. The moving plate 20 is provided with a second guide column 24 configured to be inserted into the second water inlet 32. The water flowing from the second water dividing cavity 16 can act on the second guide column 24 through its water pressure to drive the moving plate 20 to move downward, so that the ejection pins 21 can be inserted into the nozzles 11 to perform descaling.

In an embodiment, the second guide column 24 can be provided with a downwardly recessed groove 241. The water flowing from the second water dividing cavity 16 can act in the downwardly recessed groove 241 through the second water inlet 32, so as to move the moving plate 20 downward.

In an embodiment, the shower head further includes a sealing ring 25 provided between an outer peripheral wall of the second guide column 24 and an inner wall of the second water inlet 32, so as to prevent the water from flowing into a gap between the outer peripheral of the second guide column 24 and the inner wall of the second water inlet 32, so that the water flowing into the downwardly recessed groove 241 can fully act on the second guide column 24 to drive the moving plate 20 to move downward. In this case, no water flows out of the nozzles 11. In another embodiment, the housing 10 is further provided with a second water outlet cavity in communication with the second water inlet 32 and the nozzles 11. The water flowing into the second water inlet 32 can flow out of the nozzles 11 through the second water outlet cavity. In this case, the second guide column 24 bears part of the water pressure of the water flowing from the second water dividing cavity 16 to drive the moving plate 20 to move downward.

Referring to FIG. 4, the housing 10 is further provided with a water inlet cavity 17 in communication with an external water source. The shower head further includes a water dividing sheet 50 rotatably received in the water inlet cavity 17. The water dividing sheet 50 is rotated to allow the water to flow into the first water inlet 31 or the second water inlet 32. A plurality of sealing members 51 are provided between the water dividing sheet 50 and the water dividing tray 40. The water dividing sheet 50 is provided with a plurality of water dividing ports. The water dividing tray 40 is provided with a plurality of water inlet ports in communication with the plurality of water dividing ports, respectively. Each water inlet port corresponds to one of the first water dividing cavity 13 and the second water dividing cavity 16. The water dividing sheet 50 is rotated to communicate different water dividing ports with different water inlet ports, so as to allow the water to flow into the corresponding water inlet port and water dividing cavity. In this way, the water can be switched by the rotation of the water dividing sheet 50 to flow into the first water dividing cavity 13 or the second water dividing cavity 16, then the water can flow into the first water inlet 31 or the second water inlet 32.

In an embodiment, the housing 10 is further provided with a water inlet channel 60 in communication with the external water source and the water inlet cavity 17. The water is transported to the water inlet cavity 17 through the water inlet channel 60.

Referring to FIGS. 1 to 3, in an embodiment, the shower head further includes a switching assembly 70 mounted on the housing 10. The switching assembly 70 is connected to the water dividing sheet 50 and is configured to drive the water dividing sheet 50 to rotate. In an embodiment, the switching assembly 70 includes a push button 71 provided on the housing 10, a push rod 72, a gear 74, and rotating shaft 75 that are located in the housing 10. The push rod 72 is drivingly connected to the push button 71. The push rod 72 is provided with a rack 73 engaged with the gear 73. One end of the rotating shaft 75 is fixed to the gear 74. The other end of the rotating shaft 75 is located in the water inlet cavity 17 and is fixed to the water dividing sheet 50. The push button 71 is pushed to move to drive the rotating shaft 75 to rotate, thereby driving the water dividing sheet 50 to rotate to switch the water flow, and then switch whether to perform descaling.

In the shower head, the water enters the water inlet cavity 17 in the housing 10 through the water inlet channel 60, flows through the water dividing tray 40 and different water dividing cavities, and then flows out from different nozzles 11 on the panel 12. When in use, the push button 71 is pushed to drive the water dividing sheet 50 to rotate, so as to switch the water from different water dividing cavities to flow out and adjust the position of the moving plate 20. When the water flows into the first water dividing cavity 13, the water flows from bottom to top into the first water outlet cavity 15. The water pressure is not relieved, so that the moving plate 20 can be lifted. In this case, the moving plate 20 and the ejection pins 21 move away from the nozzles 11, and the water can flow out from the nozzles 11. When the push button 71 is pushed to a position where the water flows into the second water dividing cavity 16, the water acts on the second guide column 24. Due to the action of the sealing ring 25, the moving plate 20 moves downward under the action of the water pressure, and the ejection pins 21 are inserted into the nozzles 11. If there are scales in the nozzles 11, the scales will be ejected out of the nozzles 11 by the ejection pins 21 to achieve descaling. When the push button 71 is pushed again to a position where the water flows into the first water dividing cavity 13, there is no water to flow into the second water dividing cavity 16, the ejection pins 21 can be discharged from the water inlet holes 11 again, thus achieving the switch between water discharge and descaling.

Although the respective embodiments have been described one by one, it should be appreciated that the respective embodiments will not be isolated. Those skilled in the art can apparently appreciate upon reading the disclosure of this application that the respective technical features involved in the respective embodiments can be combined arbitrarily between the respective embodiments as long as they have no collision with each other. Of course, the respective technical features mentioned in the same embodiment can also be combined arbitrarily as long as they have no collision with each other.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall all fall within the protection scope of the present disclosure. Therefore, the protection scope of the present disclosure shall be subject to the protection scope of the appended claims.

What is claimed is:

1. A shower head with descaling ability, comprising:
a housing provided with a plurality of nozzles; and
a moving plate movably received in the housing and provided with a plurality of ejection pins configured to be inserted into the plurality of nozzles, respectively;
wherein the shower head is further provided with a first water inlet and a second water inlet, water flowing into the first water inlet flows below the moving plate and drives the moving plate to move away from the nozzles, so that the ejection pins are disengaged from the nozzles and the water then flows out from the nozzles, the water flowing into the second water inlet flows above the moving plate and presses the moving plate to move towards the nozzles, so that the ejection pins are inserted into the nozzles to eject scales out of the nozzles.

2. The shower head according to claim 1, wherein the housing comprises a panel, the nozzles are provided on the panel, the shower head further comprises a water separating plate and a water dividing tray that are provided in the housing, the moving plate is movably provided between the water separating plate and the panel, and the water dividing tray is located on a side of the water separating plate away from the panel.

3. The shower head according to claim 2, wherein a first water dividing cavity is formed between the water dividing tray and the water separating plate, the first water dividing cavity is in communication with the first water inlet, the water flowing into the first water dividing cavity flows below the moving plate through the first water inlet, the water separating plate is provided with a first guide column, the first water inlet extends through the first guide column, the moving plate is provided with a first guide hole, and the first guide column is inserted into the first guide hole.

4. The shower head according to claim 3, wherein the panel is provided with a connecting ring surrounding the first guide column, a top surface of the connecting ring is higher than or flush with a bottom surface of the first guide column, a first water outlet cavity is formed between the panel and the moving plate, and the first water outlet cavity is in communication with the first water inlet and the plurality of nozzles.

5. The shower head according to claim 4, wherein a lower end surface of the moving plate is provided with an upwardly recessed groove located above the connecting ring, the water flowing into the first water inlet flows to the connecting ring and then flows upward to the upwardly recessed groove, and flows downward into the first water outlet cavity and flows out from the nozzles.

6. The shower head according to claim 2, wherein a second water dividing cavity is formed between the water dividing tray and the water separating plate, the second water inlet is formed in the water separating plate, the second water dividing cavity is in communication with the second water inlet, the water flowing into the second water dividing cavity flows above the moving plate through the second water inlet, and the moving plate is provided with a second guide column configured to be inserted into the second water inlet.

7. The shower head according to claim 6, further comprising a sealing ring provided between an outer peripheral wall of the second guide column and an inner wall of the second water inlet.

8. The shower head according to claim 7, wherein the second guide column is provided with a downwardly recessed groove, and the water from the second water dividing cavity acts in the downwardly recessed groove through the second water inlet, so as to move the moving plate downward.

9. The shower head according to claim 2, wherein the housing is further provided with a water inlet cavity, the shower head further comprises a water dividing sheet rotatably received in the water inlet cavity, the water dividing sheet is rotated to allow the water to flow into the first water inlet or the second water inlet, and a plurality of sealing members are provided between the water dividing sheet and the water dividing tray.

10. The shower head according to claim 9, further comprising a switching assembly mounted on the housing, wherein the switching assembly is connected to the water dividing sheet and is configured to drive the water dividing sheet to rotate.

11. The shower head according to claim 10, wherein the switching assembly comprises a push button provided on the housing, a push rod, a gear, and a rotating shaft that are located in the housing, the push rod is drivingly connected to the push button, the push rod is provided with a rack engaged with the gear, one end of the rotating shaft is fixed to the gear, and another end of the rotating shaft is located in the water inlet cavity and is fixed to the water dividing sheet.
